(19) United States
(12) Patent Application Publication
(10) Pub. No.: US 2026/0259355 A1
(43) Pub. Date: Sep. 3, 2026

(54) Optically Diffusive Film and Optical System Including Same

(71) Applicant: 3M INNOVATIVE PROPERTIES COMPANY, St. Paul, MN (US)

(72) Inventors: Benjamin F. Forsythe, Stillwater, MN (US); David A. Rosen, North Saint Paul, MN (US); Stephen A. Johnson, Woodbury, MN (US); Carl A. Stover, St. Paul, MN (US)

(21) Appl. No.: 18/868,227

(22) PCT Filed: May 18, 2023
(86) PCT No.: PCT/IB2023/055137

§ 371 Date: Nov. 22, 2024

Related U.S. Application Data
(60) Provisional application No. 63/350,067, filed on Jun. 8, 2022.

(51) Int. Cl. G02B 5/02; G02B 1/04

(52) U.S. Cl. CPC G02B 5/0242; G02B 5/0278; G02B 1/04

(57) ABSTRACT

An optically diffusive film includes a plurality of particles dispersed in a binder. The particles and the binder have respective indices n1b and n2b along a same in-plane block-direction of the optically diffusive film, and respective indices n1p and n2p along an in-plane pass-direction orthogonal to the block-direction, such that for at least a first wavelength in a visible wavelength range extending from about 420 nm to about 680 nm: a magnitude of a difference between n1b and n2b is greater than about 0.04; and a magnitude of a difference between n1p and n2p is less than about 0.05. For a substantially collimated substantially normally incident light, for the visible wavelength range, and polarization states along the block- and the pass-directions, the optically diffusive film can have respective total optical transmittances TT(B) and TT(P) and respective diffuse optical transmittances TD(B) and TD(P), where TD(B)/TT(B)≥0.7 and TD(P)/TT(P)≥0.15.

### SUMMARY

The present description generally relates to optically diffusive films that include particles dispersed in a binder and to optical systems that include a display and the optically diffuse film. The optically diffusive film may be more optically diffusive for a light polarized along a block-direction and less optically diffusive for light polarized along an orthogonal pass-direction. The optically diffusive film may scatter light polarized along the block-direction more strongly in in a plane parallel to the pass-direction and less strongly in a plane parallel to the block-direction.

In some aspects, the present description provides an optically diffusive film including a plurality of particles dispersed in a binder. The particles and the binder have respective indices n1b and n2b along a same in-plane block-direction of the optically diffusive film, and respective indices n1p and n2p along an in-plane pass-direction orthogonal to the block-direction, such that for at least a first wavelength in a visible wavelength range extending from about 420 nm to about 680 nm: a magnitude of a difference between n1b and n2b is greater than about 0.04; and a magnitude of a difference between n1p and n2p is less than about 0.05. For a substantially collimated substantially normally incident light, for the visible wavelength range, and polarization states along the block- and the pass-directions, the optically diffusive film can have respective total optical transmittances TT(B) and TT(P) and respective diffuse optical transmittances TD(B) and TD(P), where TD(B)/TT(B)≥0.7 and TD(P)/TT(P)≥0.15.

In some aspects, the present description provides an optically diffusive film including a plurality of particles dispersed in a binder and elongated along an in-plane block-direction orthogonal to an in-plane pass direction and a thickness-direction of the optically diffusive film. The particles have average lengths Lb and Lz along the respective block- and thickness-directions, where Lb/Lz can be greater than about 10. For at least a first wavelength in a visible wavelength range extending from about 420 nm to about 680 nm, a magnitude of a difference between indices of refraction of the particles and the binder along the block-direction is at least about 0.04, and a magnitude of a difference between indices of refraction of the particles and the binder along the pass-direction is less than about 0.05. For a substantially collimated substantially normally incident light and for the visible wavelength range: for the incident light polarized along the pass-direction, a specular optical transmittance of the optically diffusive film versus wavelength has a standard of deviation greater than about 2%; and for the incident light polarized along the block-direction, the optically diffusive film has respective diffuse and specular optical transmittances TD(B) and TS(B), where TD(B)/TS(B) can be greater than about 2.

In some aspects, the present description provides an optically diffusive film including a plurality of particles dispersed in a binder and elongated along an in-plane block-direction orthogonal to an in-plane pass direction and a thickness-direction of the optically diffusive film. The particles have average lengths Lb and Lz along the respective pass- and thickness-directions, where Lb/Lz can be greater than about 10. For at least a first wavelength in a visible wavelength range extending from about 420 nm to about 680 nm, a magnitude of a difference between indices of refraction of the particles and the binder along the block-direction is at least about 0.04, and a magnitude of a difference between indices of refraction of the particles and the binder along the pass-direction is less than about 0.05. For a substantially collimated substantially normally incident light polarized along the block-direction and for the first wavelength, an optical transmittance of the optically diffusive film as a function of transmission angle includes a substantially linear segment extending at least from about 10 degrees to about 60 degrees. The substantially linear segment can have a best linear fit with an r-squared value greater than about 0.8.

In some aspects, the present description provides an optical system including a display configured to emit an image for viewing by a viewer; and an optically diffusive film disposed between the display and the viewer for diffusely transmitting the emitted image primarily along a viewing direction substantially parallel to the display so that the transmitted image has full viewing angles A(p) and A(b) along the respective viewing direction and a non-viewing direction orthogonal to the viewing direction and substantially parallel to the display, where A(p)/A(b)≥2. For a substantially collimated substantially normally incident light and for a visible wavelength range extending from about 420 nm to about 680 nm: the optically diffusive film has total optical transmittances TT(B) greater than about 40% and TT(P) greater than about 60% for the incident light polarized along the respective non-viewing and viewing directions; and for the incident light polarized along the non-viewing direction and for a first wavelength in the visible wavelength range, the optically diffusive film can have an average normalized optical transmittance of greater than about 0.2 over transmission angles of between about 5 degrees and about 20 degrees.

These and other aspects will be apparent from the following detailed description. In no event, however, should this brief summary be construed to limit the claimable subject matter.

### BRIEF DESCRIPTION OF THE DRAWINGS

FIG. 1 is a schematic top view of an optically diffusive film, according to some embodiments.

FIG. 2 is a schematic cross-sectional view of an optically diffusive film, according to some embodiments.

FIG. 3 is a schematic top perspective view of an optically diffusive film, according to some embodiments.

FIGS. 4-5 are plots of optical reflectance versus wavelength for exemplary and comparative optically diffusive films for substantially normally incident light having polarization states along the block- and pass-directions, respectively.

FIGS. 6-7 are plots of optical transmittance versus wavelength for exemplary and comparative optically diffusive films for substantially normally incident light having polarization states along the block- and pass-directions, respectively.

FIG. 8 is a plot of normalized optical transmittance versus transmission angle for exemplary and comparative optically diffusive films.

FIG. 9 shows a portion of a plot of an optical transmittance of FIG. 8.

FIG. 10 is a schematic cross-sectional view of an optical system, according to some embodiments.

FIG. 11 is a schematic process flow diagram of a method of making an optically diffusive film, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some embodiments of the present description, an optically diffusive film has a higher haze for light polarized along a first direction (which may also be referred to as a “block” direction) than for light polarized along an orthogonal second direction (which may also be referred to as a “pass” direction) and may have a larger scattering in a plane define by the second direction and a thickness direction than in a plane defined by the first and thickness directions. The optically diffusive film may be useful, for example, in display or sensor applications. For example, a display can be constructed where light passes through a liquid crystal display (LCD) panel with a narrow viewing angle (e.g., after passing through crossed prism films) and on the exit side of the LCD panel, the optically diffusive film can be disposed with the second direction oriented horizontally to broaden the viewing angle in the horizontal plane. As another example, the optically diffusive film can be used with a ¼ wave retarder on an optical device (e.g., an optical sensor) so that when light polarized along the block direction is incident on the device with a broad angular distribution and any such light that is reflected from the device back toward the optically diffusive film through the retarder is incident on the optically diffusive film in the lower scattering pass state and/or so that when light polarized along the pass direction is incident on the device with a narrow angular distribution and any such light reflected from the device back toward the optically diffusive film through the retarder is incident on the optically diffusive film in the block state and is substantially transmitted through the optically diffusive film with a wider angular distribution.

According to some embodiments of the present description, an optically diffusive film includes a plurality of particles dispersed in a binder where the particles are substantially optically isotropic (e.g., a difference between largest and smallest refractive indices of the particles for at least one wavelength in a range of about 400 nm to about 1000 nm can be less than about 0.05, or less than about 0.04, or less than about 0.03, or less than about 0.02, or less than about 0.01) and where the binder is birefringent (e.g., a difference between largest and smallest refractive indices of the binder for at least one wavelength in a range of about 400 nm to about 1000 nm can be greater than about 0.04, or greater than about 0.045, or greater than about 0.05, or greater than about 0.06, or greater than about 0.07, or greater than about 0.08, or greater than about 0.09, or greater than about 0.1 and the difference may be up to about 0.35, or up to about 0.3, or up to about 0.25, for example). A difference in refractive indices of the binder and the particles can be substantially different (e.g., differ by greater than about 0.05, or greater than about 0.06, or greater than about 0.07, or greater than about 0.08, or greater than about 0.09, or greater than about 0.1 and the difference may be up to about 0.35, or up to about 0.3, or up to about 0.25, for example) along a first direction and substantially matched (e.g., differ by less than about 0.05, or less than about 0.04, or less than about 0.03, or less than about 0.02, or less than about 0.01) along an orthogonal second direction. The at least one wavelength can be or include at least a first wavelength in a visible wavelength range extending from about 420 nm to about 680 nm. The first wavelength can be about 631 nm or about 633 nm, for example. The particles may be elongated along the first direction which can result in larger scattering in the second direction (i.e., in a scattering plane comprising the second direction) than in the first direction.

The optical properties of the optically diffusive film can be adjusted by selecting the binder and particle materials to have differences in refractive indices in desired ranges along the block and pass axes, adjusting the number or volume of the particles, and adjusting the shape of the particles. Increasing the refractive index difference in the block direction generally increases scattering in the block polarization state. Increasing the number of particles (e.g., by coextruding a greater volume of a minor phase material in an immiscible blend of the minor phase material with a major phase material) also increases the scattering. The index difference and the number of particles can be selected to result in mostly forward scattering, for example. It has been found that when the index differences and the aspect ratio (e.g., Lb/Lz greater than about 100 or in a range described elsewhere herein), for example, are suitably chosen, an optical transmittance of the optically diffusive film versus transmission angle can have linear segment(s), as described further elsewhere herein, which can be desired in some applications, such as providing a desired full viewing angle in display applications, for example. It has also been found that averages, standard deviations and/or ratios of total, diffuse, and/or specular transmittance and/or reflectance can be controlled to be in desired ranges for the block and polarization states which have been found to be useful in display applications, for example, by suitable selection of the index differences and the aspect ratio, for example.

The optically diffusive film can be formed by extrusion followed by stretching as described further elsewhere herein. The draw ratio used in the stretching can affect the refractive index of the binder (e.g., increasing in the draw direction for positively birefringent polymers) and the shape of the particles (e.g., resulting in particles elongated along the draw direction). The draw ratio can be at least about 1:1, or at least about 2:1, or at least about 3:1, or at least about 4:1, or at least about 4.5:1 and may be up to about 30:1, or up to about 20:1, or up to about 15:1, or up to about 10:1, or up to about 8:1, or up to about 7:1, for example. The draw ratio may be in a range from about 3:1 to about 10:1, or from about 4:1 to about 8:1, or from about 4.5:1 to about 7:1, for example. It has been found that elongating the particles along the draw direction, which may also be the block direction, can result in increased scattering in a scattering plane orthogonal to draw direction. The draw direction can be in the machine direction (MD) which can be substantially parallel to the extrusion direction. The particles can be extruded such that the particles are already partially elongated along the machine direction upon extrusion and then drawing substantially further increases the elongation of the particles resulting in high aspect ratio particles (e.g., Lb/Lz greater than about 100 or in a range described elsewhere herein).

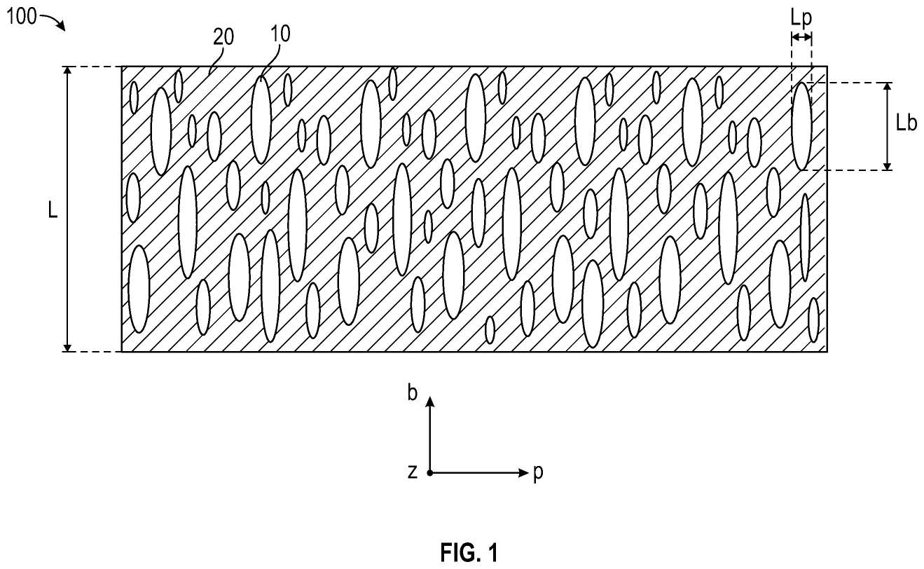

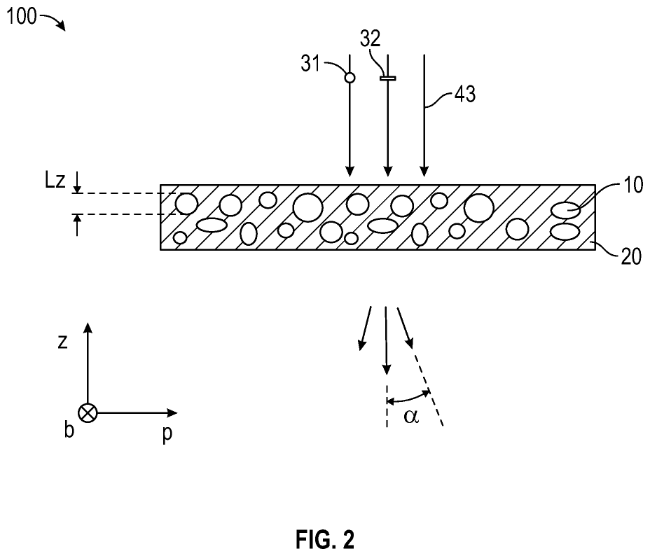

FIGS. 1-2 are schematic top and cross-sectional views, respectively, of an optically diffusive film 100 including particles 10 dispersed in a binder 20, according to some embodiments. The film 100 extends along orthogonal in-plane first (block direction or b-direction) and second (pass direction or p-direction) directions and has a thickness along a z-direction orthogonal to the b- and p-directions. The particles 10 are elongated along the b-direction. The particles can have an average length Lb along the block or draw direction, an average length Lp along the pass direction, and an average length Lz along the thickness direction (z-direction). The particles 10 can have an Lb/Lp and/or Lb/Lz ratio substantially higher than schematically illustrated in FIGS. 1A-1B. In some embodiments, Lb/Lz is greater than about 10, or 20, or 30, or 40, or 50, or 60, or 70, or 80, or 90, or 100, or 125, or 150, or 175, or 200, or 225, or 250, or 275. Lb/Lz can be up to about 1000, 700, 500, or 400, for example. The film generally contracts in the thickness direction when stretched in the b-direction and this increases Lb/Lz. For example, when the film is constrained in the transverse direction (TD or p-direction) while being stretched in the machine direction (MD or b-direction), the thickness contracts by approximately the same draw ratio used to stretch the film in the machine direction so that Lb/Lz increases by approximately the square of the draw ratio. In some embodiments, Lb/Lp is at greater than about 5, or 10, or 20, or 30, or 40. Lb/Lp can be up to about 200, 150, or 100, for example.

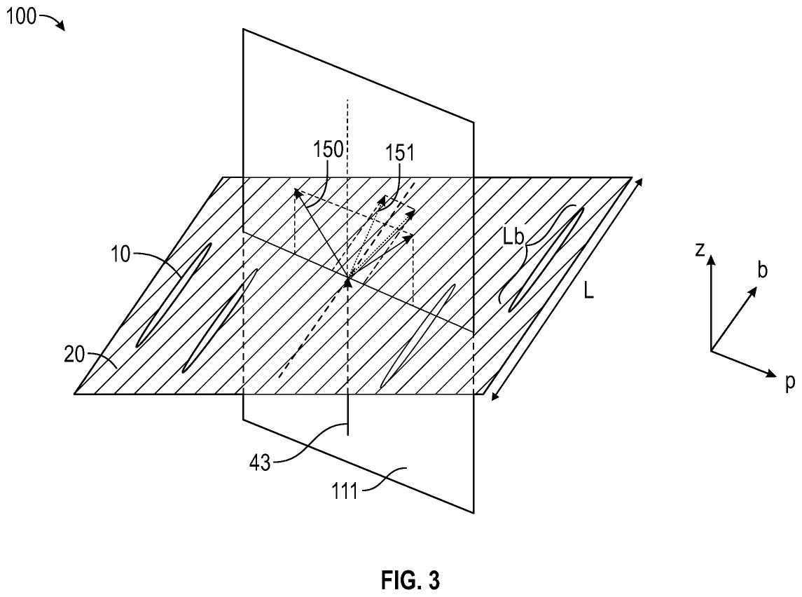

The film 100 has a length L which may be greater than about 40 inches, or greater than about 45 inches, or greater than about 50 inches, or greater than about 55 inches, or greater than about 60 inches along the block-direction. The length L can be substantially larger than schematically illustrated in FIG. 1 or 3. For example, the film 100 can be formed by extrusion along the b-direction and may be formed in a continuous roll-to-roll process where the length L can be tens or hundreds of yards, for example. The film 100 may have an average thickness in a range of about 30 to about 250 micrometers, or about 40 to about 200 micrometers, or about 50 to about 150 micrometers, for example.

A substantially collimated light 43 substantially normally incident on the optically diffusive film 100 is schematically illustrated in FIG. 2. Substantially normally incident light may be within 30 degrees, or 20 degrees, or 10 degrees of normal, or may be nominally normal, for example. For obliquely incident light, the light may be described as polarized along the block- or pass-directions when the polarization state projected onto the bp-plane is along the respective block- or pass-directions. Substantially collimated light can have a divergence/convergence angle of less than about 30 degrees, or 20 degrees, or 10 degrees, or 5 degrees, for example. The divergence/convergence angle can be substantially less than a transmission angle of interest, for example. Block- and pass-polarizations states 31 and 32 are schematically illustrated. For at least the block polarization state 31, the light 43 may be scattered at least in the pz-plane. A scattering angle α is schematically illustrated.

FIG. 3 is a schematic top perspective view of optically diffusive film 100, according to some embodiments. For the block polarization state 31, the substantially normally incident light is scattered more along the p-direction (in the scattering plane 111 defined by the p- and thickness-directions) and less along the b-direction. Cones 150 and 151 of transmitted light along the respective p- and b-directions are schematically illustrated.

The optically diffusive film 100 may be characterized one or more of total, diffuse, or specular optical transmittance or reflectance. A total optical reflectance can be determined by measuring the reflectance using an integrating sphere to collect all reflected light of a given wavelength or wavelength range. A diffuse optical reflectance, which may also be referred to as a specular excluded reflectance, can be determined by measuring the reflectance using an integrating sphere where light corresponding to a specular reflection is allowed to escape from the integrating sphere. Alternatively, in some embodiments, the total and diffuse optical reflectances may approximated as 100% minus total and diffuse transmittances, respectively, which may be determined according to the ASTM D1003-13 test standard. A specular optical reflectance can be determined as a difference between total and diffuse optical reflectances.

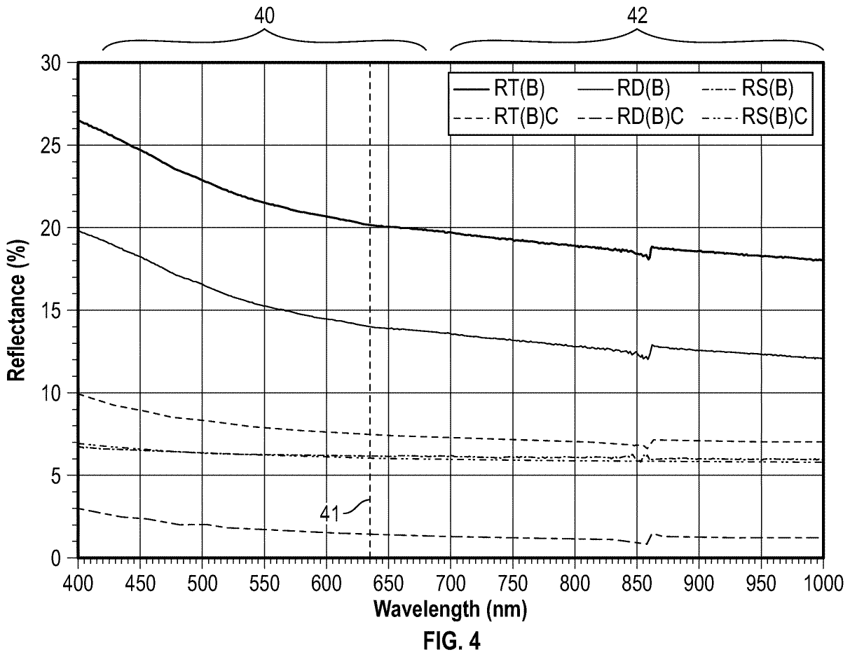

The binder 20 and the particles 10 have refractive indices along each of the illustrated b-, p-, and z-directions. In some embodiments, an optically diffusive film 100 includes a plurality of particles 10 dispersed in a binder 20, where the particles and the binder have respective indices n1b and n2b along a same in-plane (pb-plane) block-direction (b-direction) of the optically diffusive film 100, and respective indices n1p and n2p along an in-plane pass-direction (p-direction) orthogonal to the block direction, such that for at least a first wavelength (e.g., wavelength 41 schematically illustrated in FIGS. 4-7) in a visible wavelength range (e.g., wavelength range 40 schematically illustrated in FIGS. 4-7) extending from about 420 nm to about 680 nm: a magnitude of a difference between n1b and n2b is greater than about 0.04; and a magnitude of a difference between n1p and n2p is less than about 0.05. In some such embodiments, or in other embodiments, for at least the first wavelength, a magnitude of a difference between n1b and n2b is greater than about 0.04, or greater than about 0.045, or greater than about 0.05, or greater than about 0.055, or greater than about 0.06, or greater than about 0.065, or greater than about 0.07, or greater than about 0.075. In some such embodiments, or in other embodiments, for at least the first wavelength, a magnitude of a difference between n1p and n2p is less than about 0.05, or less than about 0.045, or less than about 0.04, or less than about 0.035, or less than about 0.03, or less than about 0.025, or less than about 0.02. For example, in some embodiments, a magnitude of a difference between n1b and n2b is greater than about 0.055 and a magnitude of a difference between n1p and n2p is less than about 0.04. The at least the first wavelength may include one or more of about 532 nm, about 550 nm, about 631 nm, about 633 nm, or about 650 nm, for example. Typically, the magnitude of the difference between n1b and n2b is greater than the magnitude of the difference between n1p and n2p by at least about 0.005, or at least about 0.01, or at least about 0.015, or at least about 0.02, or at least about 0.025, or at least about 0.03, or at least about 0.035.

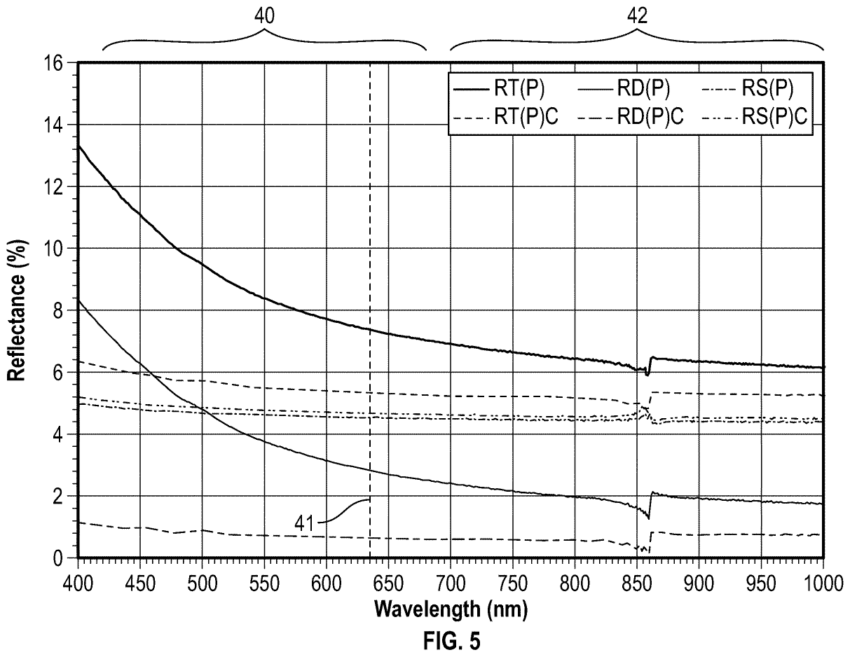

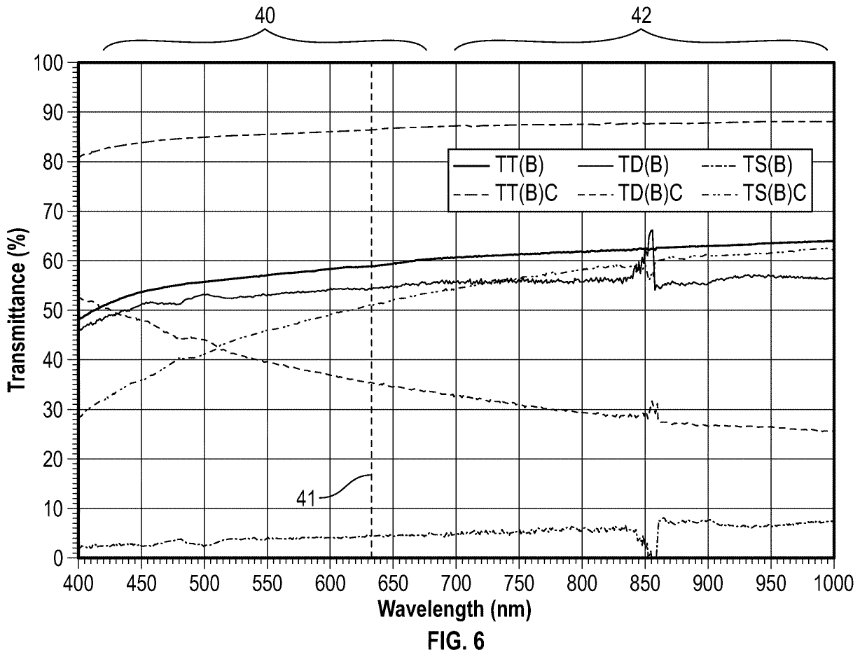

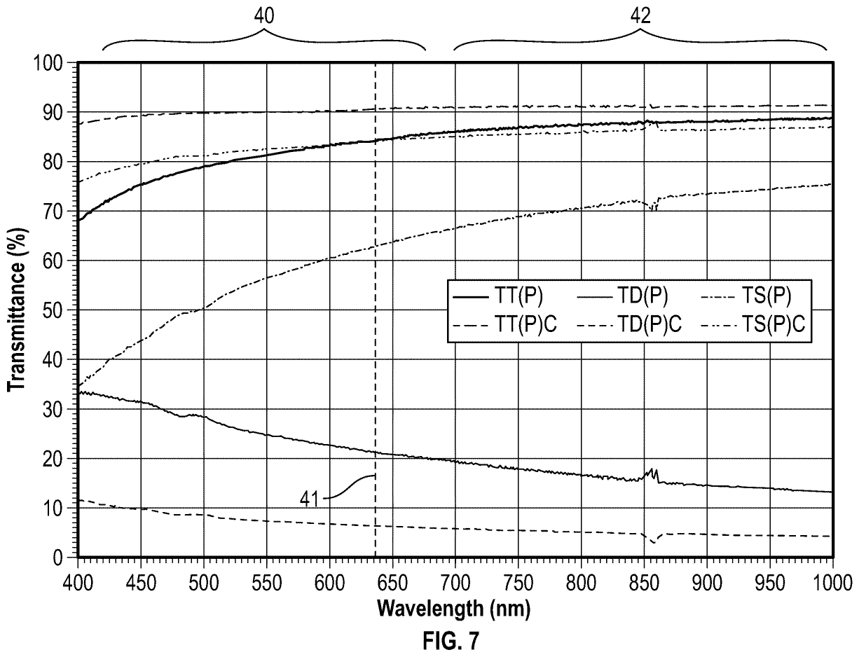

FIGS. 4-5 are plots of optical reflectance versus wavelength for exemplary and comparative optically diffusive films for substantially normally incident light having polarization states along the block- and pass-directions, respectively. FIGS. 6-7 are plots of optical transmittance versus wavelength for exemplary and comparative optically diffusive films for substantially normally incident light having polarization states along the block- and pass-directions, respectively. The curves in these figures are denoted with a label for reflectance (R) or transmittance (T); a label for total (T), diffuse (D), or specular(S); and, in parentheses, a label for block (B) or pass (P) polarizations states. Curves for an exemplary optically diffusive film and for a comparative optically diffusive film made by stretching the film in the transverse direction rather than the machine direction are shown. The curves for the comparative film are labeled with a C after the polarization state.

In some embodiments, for the substantially collimated substantially normally incident light 43, for the visible wavelength range 40, and the polarization state 32 along the pass-direction, the optically diffusive film 100 has a total optical transmittance TT(P) and a diffuse optical transmittance TD(P), where TD(P)/TT(P)≥0.15, 0.2, 0.25, or 0.3. TD(P)/TT(P) can be up to 0.5 or 0.4, for example. In some embodiments, for a substantially collimated substantially normally incident light 43, for the visible wavelength range 40, and polarization states 31 and 32 along the block- and the pass-directions, the optically diffusive film 100 has respective total optical transmittances TT(B) and TT(P) and respective diffuse optical transmittances TD(B) and TD(P), where TD(B)/TT(B)≥0.7, 0.75, 0.8, 0.85, or 0.9; and TD(P)/TT(P) can be as described above. In some embodiments, TD(B)/TT(B) is greater than TD(P)/TT(P) by at least 0.1, or 0.2, or 0.3, or 0.4, or 0.5, or 0.6. TD(B)/TT(B) can be greater than TD(P)/TT(P) by up to about 0.9 or 0.8, for example.

In some embodiments, for a substantially collimated substantially normally incident light 43, for an infrared wavelength range 42 extending from about 700 nm to about 1000 nm, and polarization states 31 and 32 along the block- and the pass-directions, the optically diffusive film 100 has respective total optical transmittances TT′(B) and TT′(P) and respective diffuse optical transmittances TD′(B) and TD′(P), where TD′(B)/TT′(B) is greater than TD′(P)/TT′(P) by at least 0.4, or 0.45, or 0.5, or 0.55, or 0.6, or 0.65, or 0.7. TD′(B)/TT′(B) may be greater than TD′(P)/TT′(P) by up to about 0.9 or 0.8, for example.

In some embodiments, for a substantially collimated substantially normally incident light 43 and for the visible wavelength range 40 extending from about 420 nm to about 680 nm: for the incident light polarized along the pass-direction (p-direction), a specular optical transmittance TS (P) of the optically diffusive film 100 versus wavelength has a standard of deviation that can be greater than about 2%; and for the incident light polarized along the block-direction, the optically diffusive film has respective diffuse and specular optical transmittances TD(B) and TS(B), where TD(B)/TS(B) is greater than about 2. The standard of deviation of the specular optical transmittance TS (P) versus wavelength can be greater than about 3%, or 4%, or 5%, or 6%, or 7%. The standard of deviation can be up to 15%, 12%, or 10%, for example. TD(B)/TS(B) can be greater than about 4, or 6, or 8, or 10, or 12, or 14. TD(B)/TS(B) can be up to 25, 20, or 18, for example.

The total, diffuse, and/or specular optical transmittance in a specified wavelength range (e.g., 420 nm to 680 nm or 700 nm to 1000 nm) can be the average total, diffuse, and/or specular optical transmittance, respectively, averaged over the specified wavelength range. Average of optical transmittances (in percent) and standard deviations (in percent) of the optical transmittances for the exemplary optically diffusive film of FIGS. 4-7 for visible and infrared wavelength ranges are shown in the following table.

| Wavelength | | | | | | |
|---|---|---|---|---|---|---|
| range (nm) | TT(B) | TD(B) | TS(B) | TT(P) | TD(P) | TS(P) |
| 420-680 (avg): | 56.8 | 53.0 | 3.8 | 80.7 | 25.6 | 55.1 |
| 420-680 (std): | 2.3 | 1.7 | 0.7 | 3.7 | 3.9 | 7.6 |
| 700-1000 (avg): | 62.4 | 56.4 | 6.0 | 87.8 | 16.0 | 71.8 |
| 700-1000 (std): | 1.0 | 1.4 | 1.6 | 0.7 | 1.8 | 2.5 |

Optical transmittances (in percent) and standard deviations (in percent) of the optical transmittances for the comparative optically diffusive film of FIGS. 4-7 for visible and infrared wavelength ranges are shown in the following table.

| Wavelength | | | | | | |
|---|---|---|---|---|---|---|
| range (nm) | TT(B) | TD(B) | TS(B) | TT(P) | TD(P) | TS(P) |
| 420-680 (avg): | 85.4 | 40.6 | 44.8 | 90.1 | 7.8 | 82.3 |
| 420-680 (std): | 1.1 | 5.0 | 6.1 | 0.6 | 1.3 | 1.8 |
| 700-1000 (avg): | 87.7 | 28.6 | 59.1 | 91.3 | 5.0 | 86.3 |
| 700-1000 (std): | 0.3 | 2.1 | 2.4 | 0.1 | 0.5 | 0.6 |

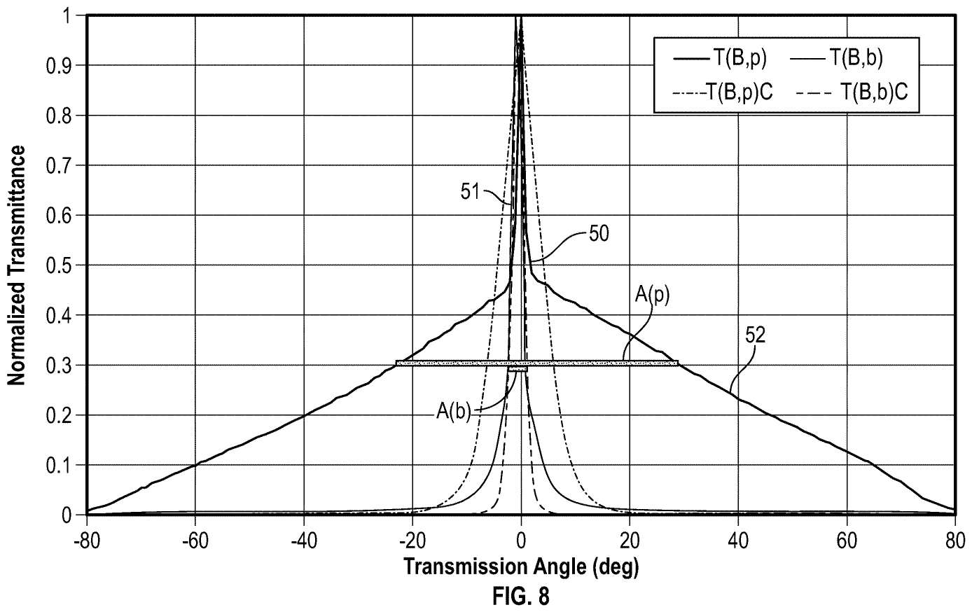

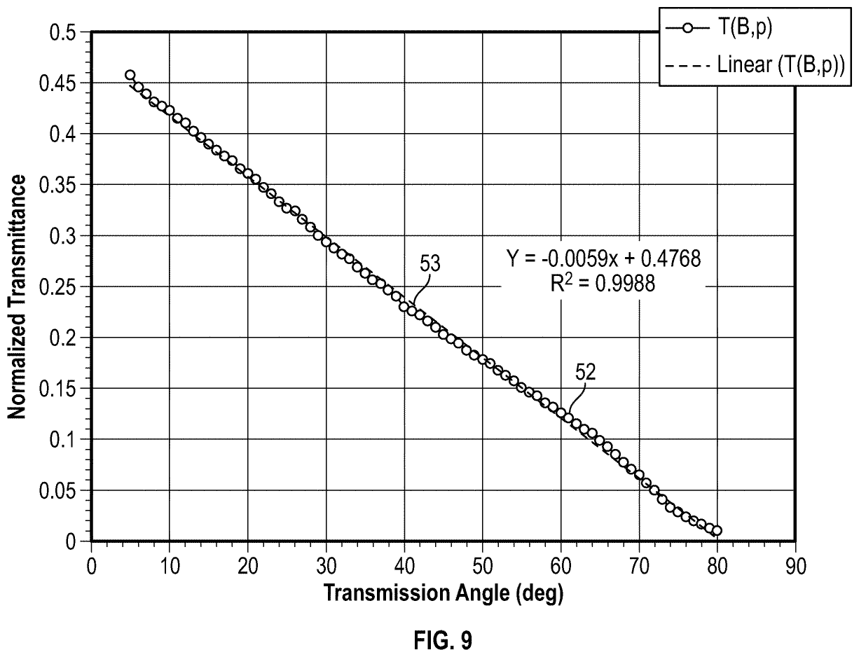

FIG. 8 is a plot of normalized optical transmittance versus transmission angle (e.g., corresponding to the angle α schematically illustrated in FIG. 2) for exemplary and comparative optically diffusive films for substantially collimated substantially normally incident light 43 polarized along the block-direction (b-direction). The transmission angle is along the direction indicated by a lower case p or b, while the polarization state is indicated by an upper case Por B. For example, T(B,p) indicates transmittance for the block (B) polarization state for transmission angle along the p-direction (or in the pz-plane). Results for a comparative optically diffusive film (indicated by a C) stretched along the transverse direction are also shown. The normalized optical transmittance is the total optical transmittance normalized (scaled by a constant factor) such that the maximum of the normalized optical transmittance is unity. The data shown in FIG. 8 was determined using a white light emitting diode (LED) collimated light source. In some embodiments, for a substantially collimated substantially normally incident light 43 polarized along the block-direction and for the first wavelength 41, an optical transmittance 50 of the optically diffusive film 100 as a function of transmission angle (e.g., along the pass direction and/or in a plane defined by the pass-direction and a thickness-direction of the optically diffusive film 100) includes a substantially linear segment 52 extending at least from about 10 degrees to about 60 degrees. The substantially linear segment 52 can extend down to about 7.5 or 5 degrees, for example. The substantially linear segment 52 can extend up to about 65, or 70, or 75, or 80 degrees, for example. A substantially linear segment can be understood to be a segment that appears approximately linear and that has best linear fit (e.g., a linear least squares fit) with a coefficient of determination (commonly referred to as r-squared or R²) of at least about 0.8. FIG. 9 shows a portion of the plot of the optical transmittance of FIG. 8. In some embodiments, the substantially linear segment 52 has a best linear fit 53 with an r-squared value R² greater than about 0.8, 0.85, 0.9, or 0.95.

In some embodiments, for a substantially collimated substantially normally incident light 43 polarized along the block-direction and for the first wavelength 41, the optically diffusive film 100 diffusely transmits the incident light as a cone 50, 51 of transmitted light having respective full width at 30% maximums A(p) and A(b) along the respective pass- and block-directions, where A(p)/A(b)≥2, or 3, or 4, or 5, or 6, or 7, or 8, or 9, or 10, or 11, or 12, or 13, or 14. A(p)/A(b) can be up to 25 or 20, for example. In the embodiment illustrated in FIG. 8, A(p) is about 57 degrees and A(b) is about 4 degrees. A(p) and A(b) can alternative be determined for a visible wavelength range (e.g., for white light). In some embodiments, for the incident light polarized along the block-direction and for a first wavelength 41 in the visible wavelength range 40, the optically diffusive film 100 has an average normalized optical transmittance of greater than about 0.2, or 0.25, or 0.3, or 0.35, or 0.4 over transmission angles of between about 5 degrees and about 20 degrees. The average normalized optical transmittance over transmission angles of between about 5 degrees and about 20 degrees can be up to about 0.6 or 0.5, for example. In some embodiments, for the incident light polarized along the block-direction and for the first wavelength 41, the optically diffusive film 100 has an average normalized optical transmission of greater than about 0.1, or 0.15, or 0.2, or 0.25 over transmission angles of between about 20 degrees and about 50 degrees. The average normalized optical transmittance over transmission angles of between about 20 degrees and about 50 degrees can be up to about 0.5 or 0.4, for example. The average normalized optical transmittance over transmission angles of between about 20 degrees and about 50 degrees can be less than the average normalized optical transmittance over transmission angles of between about 5 degrees and about 20 degrees by at least about 0.05, 0.08, or 0.1, for example. In the embodiment of FIG. 8, the optically diffusive film 100 has an average normalized optical transmittance of about 0.41 over transmission angles of between about 5 degrees and about 20 degrees and about 0.27 over transmission angles of between about 20 degrees and about 50 degrees.

For some applications, a higher haze is desired for light polarized along the block-direction than for light polarized along the pass-direction. In some embodiments, the optically diffusive film 100 has an optical haze Hb for substantially normally incident light 43 polarized along the block-direction and an optical haze Hp for substantially normally incident light 40 polarized along the pass-direction, where Hb/Hp≥1.4, or Hb/Hp≥1.5, or Hb/Hp≥1.8, or Hb/Hp≥2, or Hb/Hp≥2.2, or Hb/Hp≥2.4, or Hb/Hp≥2.5. The optical haze of a film for a specified polarization state can be measured using a haze meter (e.g., a Haze-Gard haze meter available from BYK Corporation, Wesel, Germany) with an absorbing linear polarizer disposed on the film facing the light source of the haze meter with a pass axis of the polarizer aligned with the specified polarization state. The optical haze can be determined as described in the ASTM D1003-13 test standard except that the test specimen includes the absorbing linear polarizer disposed on the film. Typically, the optical haze Hb generally increases when increasing the difference in refractive indices of the particles and the binder along the block-direction and/or when increasing the number of the particles. The optical haze Hb can be high (e.g., greater than about 75% or greater than about 80%) when the refractive indices of the particles and the binder are substantially different (e.g., different by at least about 0.08 or at least about 0.1) along the block-direction, for example. The optical haze Hp can be low (e.g., less than about 2% or less than about 1%) when the refractive indices of the particles and the binder are closely matched (e.g., to within about 0.02, or about 0.01) along the pass-direction, for example. Hb/Hp may be up to about 100, or up to about 50, or up to about 25, or up to about 20, or up to about 15, or up to about 10, for example. In some embodiments, Hb is in a range of about 10% to about 100%, or about 15% to about 99%, or about 20% to about 98%, or about 25% to about 90%. In some such embodiments, or in other embodiments, Hp is in a range of about 0% to about 65%, or about 1% to about 60%, or about 2% to about 55%, or about 5% to about 50%, or about 10% to about 45%.

Any of the optical properties described herein for a visible wavelength range extending from about 420 nm to about 680 nm may hold for other visible wavelength ranges. For example, a visible wavelength range extending from about 400 nm to about 700 nm or from about 450 to about 650 nm may be used in determining average optical transmittances or other optical properties.

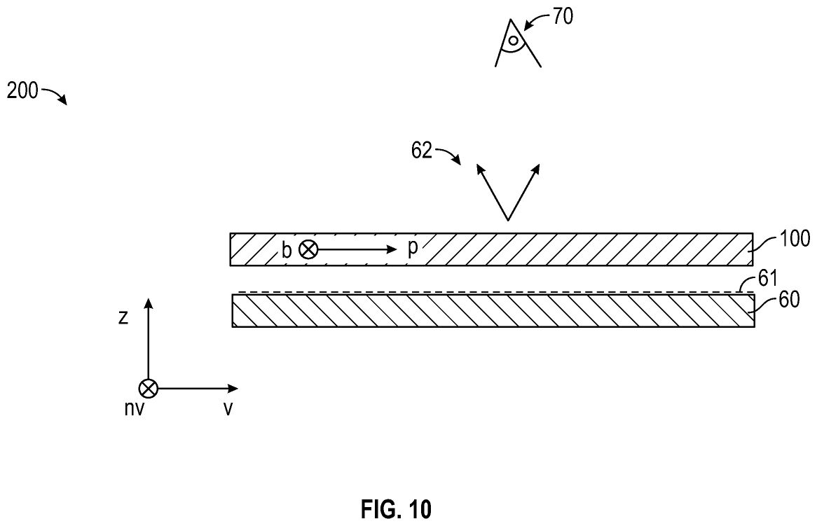

Any of the optically diffusive films of the present description can be used with a display. FIG. 10 is a schematic cross-sectional view of an optical system 200, according to some embodiments. The optical system 200 includes a display 60 configured to emit an image 61 for viewing by a viewer 70; and an optically diffusive film 100 disposed between the display 60 and the viewer 70 for diffusely transmitting the emitted image primarily along a viewing direction (v-direction) substantially parallel (e.g., parallel to within about 30, 20, 10, 5, or 3 degrees, or nominally parallel) to the display 60 so that the transmitted image has full viewing angles A(p) and A(b) along the respective viewing direction and a non-viewing direction (nv-direction) orthogonal to the viewing direction and substantially parallel to the display 60, where A(p)/A(b)≥2 or A(p)/A(b) can be in any range described elsewhere herein. A(p) and A(b) can be determined as the full widths at 30% maximum of the transmitted light as described further elsewhere herein. The viewing and non-viewing directions can be substantially parallel to the respective pass- and block-directions. Any of the optical properties specified for light polarized along the pass- and block-directions may also hold for light polarized along the viewing and non-viewing directions, respectively. Similarly, any optical properties specified for light polarized along the non-viewing and viewing directions may also hold for light polarized along the pass- and block-directions, respectively.

In some embodiments, the optically diffusive film 100 has total optical transmittances TT(B) greater than about 40% and TT(P) greater than about 60% for the incident light polarized along the respective non-viewing and viewing directions (and/or along the respective pass- and block-directions). TT(B) can be greater than about 40, 45, 50, or 55 percent. TT(B) can be up to about 90, 80, 70, or 65 percent, for example. TT(P) can be greater than about 60, 65, 70, 75, or 80 percent. TT(P) can be up to about 100, 95, 90, or 85 percent, for example. In some embodiments, for the incident light polarized along the non-viewing direction and for a first wavelength 41 in the visible wavelength range, the optically diffusive film 100 has an average normalized optical transmittance of greater than about 0.2, or 0.25, or 0.3, or 0.35, or 0.4 over transmission angles of between about 5 degrees and about 20 degrees. In some embodiments, for the incident light polarized along the non-viewing direction and for the first wavelength 41, the optically diffusive film 100 has an average normalized optical transmission of greater than about 0.1, or 0.15, or 0.2, or 0.25 over transmission angles of between about 20 degrees and about 50 degrees.

The display can be oriented to extend along horizontal and vertical directions (e.g., generally in a plane defined by the horizontal and vertical direction) to display an image to a viewer spaced apart from the display generally along a direction substantially orthogonal to the horizontal and vertical directions. The viewing direction can be substantially parallel to the horizonal direction. In some embodiments, the display has a horizonal width along the viewing direction (v-direction) and a vertical height along the non-viewing direction (nv-direction), where the horizonal width is greater than the vertical height.

In some embodiments, the binder 20 comprises a first thermoplastic polymer and the particles 10 comprise a different second thermoplastic polymer. In some embodiments, the first and second thermoplastic polymers are immiscible at a temperature greater than melting temperatures of the first and second thermoplastic polymers (i.e., at a temperature that is greater than each of a melting temperature of the first thermoplastic polymer and a melting temperature of the second thermoplastic polymer). In some such embodiments, or in other embodiments, the first thermoplastic polymer is birefringent and the second thermoplastic polymer is substantially optically isotropic.

Suitable materials for the binder 20 include, for example, polyethylene naphthalate (PEN), coPEN (copolyethylene naphthalate terephthalate copolymer), polyethylene terephthalate (PET), polyhexylethylene naphthalate copolymer (PHEN), glycol-modified PET (PETG or PETg), glycol-modified PEN (PENG), syndiotactic polystyrene (sPS), or blends thereof. Suitable sPS can be obtained from Idemitsu Kosan Co., Ltd. (Tokyo, Japan), for example. Atactic polystyrene (aPS) can optionally be blended with sPS (e.g., at about 5 to about 30 weight percent aPS) to adjust the refractive indices of the resulting layer and/or to reduce the haze of the layer (e.g., by reducing a crystallinity of the layer). Suitable PET can be obtained from Nan Ya Plastics Corporation, America (Lake City, SC), for example. PETG can be described as PET with some of the glycol units of the polymer replaced with different monomer units, typically those derived from cyclohexanedimethanol. PETG can be made by replacing a portion of the ethylene glycol (e.g., about 15 to about 60 mole percent or about 30 to about 40 mole percent) used in the transesterification reaction producing the polyester with cyclohexanedimethanol, for example. Suitable PETG copolyesters include GN071 available from Eastman Chemical Company (Kingsport, TN). PEN and coPEN can be made as described in U.S. Pat. No. 10,001,587 (Liu), for example. Glycol-modified polyethylene naphthalate (PENG) can be described as PEN with some of the glycol units of the polymer replaced with different monomer units and can be made by replacing a portion of the ethylene glycol (e.g., about 15 to about 60 mole percent or about 30 to about 40 mole percent) used in the transesterification reaction producing the polyester with cyclohexanedimethanol, for example. PHEN can be made as described for PEN in U.S. Pat. No. 10,001,587 (Liu), for example, except that a portion of the ethylene glycol (e.g., about 15 to about 60 mole percent, or about 30 to about 50 mole percent, or about 40 mole percent) used in the transesterification reaction is replaced with hexanediol. In some embodiments, the binder 20 comprises one or more of a polyester and a copolyester. For example, the binder may include a blend of a polyester and a copolyester. In some embodiments, the binder 20 comprises one or more of polyethylene terephthalate, glycol-modified polyethylene terephthalate, polyethylene naphthalate, and glycol-modified polyethylene naphthalate.

In some embodiments, the particles in the plurality of particles 10 comprise a styrene-based polymer or copolymer (a polymer or copolymer containing styrene groups). In some embodiments, the particles in the plurality of particles 10 comprise one or more of styrene butadiene, styrene acrylonitrile, styrene methyl methacrylate, and impact modified styrene acrylic. Impact modified styrene acrylic can incorporate monomer groups for improved impact resistance and/or toughness, as is known in the art. Suitable impact modified styrene acrylic include those available from Ineos Americas (League City, TX) under the ZYLAR tradename, for example. Other suitable styrene-based copolymers include those available from Ineos Americas (League City, TX) under the STYROLUX, STYROLUTION, and NAS tradenames, for example. Other classes of materials useful as the particles in the plurality of particles include polycarbonate polymers including bisphenol A; nylon polymers, such as Poly(hexamethylene adipamide) (Nylon 6,6) and Poly(caprolactam) (Nylon 6); and methacrylate polymers, such as Poly(2-phenylethyl methacrylate), for example. Choosing a polymer useful as the particles in the plurality of particles may be generally guided by choosing the polymer to substantially match the refractive index of the birefringent binder in the non-stretch in-plane direction, and by choosing the polymer being immiscible with the binder polymer system, remaining non-birefringent during the stretching process, and not degrading during the melt processing stage.

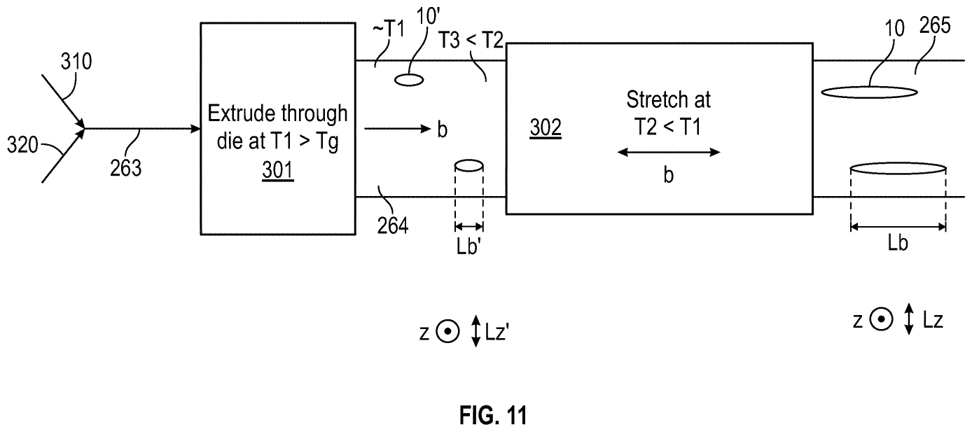

FIG. 11 is a schematic process flow diagram of a method of making an optically diffusive film, according to some embodiments. In some embodiments, a method of making an optically diffusive film 100, 265 includes: extruding (step 301) an immiscible blend 263 of a minor phase material and a major phase material 310 and 320 through a die and along a block-direction (b-direction) at a first temperature T1 greater than glass transition temperatures (Tg) of the minor and major phase materials 310 and 320 resulting in an extruded mixture 264 at substantially the first temperature T1 (e.g., within about 10° C. or within about 5° C. of T1); and stretching (step 302) the extruded mixture 264 along the block-direction (b-direction) at a second temperature T2 less than the first temperature T1 resulting in a plurality of particles 10 dispersed in a binder 20, where the binder 20 and each of at least a majority of the particles 10 have respective indices n2b and n1b along the block-direction and respective indices n2p and n1p along an in-plane pass-direction orthogonal to the block-direction, such that for at least a first wavelength in a first wavelength range extending from about 420 nm to about 680 nm, or in any wavelength range described elsewhere herein, a magnitude of a difference between n1b and n2b can be greater than about 0.05 and a magnitude of a difference between n1p and n2p can be less than about 0.05. The magnitude of the difference between n1b and n2b can be any range described elsewhere herein. The magnitude of the difference between n1p and n2p can be any range described elsewhere herein. The at least a majority of the particles 10 can include at least about 60 percent, or at least about 70 percent, or at least 80 percent, or at least about 90 percent, or substantially all of the particles 10 (by number). The at least a majority of the particles 10 can include at least about 60 percent, or at least about 70 percent, or at least 80 percent, or at least about 90 percent, or substantially all of a total mass of the particles 10. The minor phase material of the immiscible blend generally comprises less than half of a total volume of the immiscible blend and typically defines a discontinuous phase. The major phase material of the immiscible blend generally comprises greater than half of the total volume of the immiscible blend and typically defines a continuous phase. In some embodiments, the extruded mixture 264 (prior to stretching) includes a plurality of discrete domains 10′ having average lengths Lb′ and Lz′ along the block-direction and a thickness direction (z-direction) of the extruded mixture, where Lb′/Lz′ is in a range of about 3 to about 15, or about 4 to about 12, or about 5 to about 10, for example. Lb′ and Lz′ may appear generally as schematically illustrated in FIGS. 1-2 for Lb and Lz, respectively, though Lb is greater than Lb′ and Lz is typically less than Lz′. It has been found that the domains can be made more elongated by providing higher shear rates during extrusion. This can be done, for example, by using a smaller die gap with a higher extrusion rate and/or using a higher viscosity major phase material 320 (e.g., at a given temperature) and/or a lower extrusion temperature (e.g., to increase the viscosity of the major phase material 320). In some embodiments, after stretching, the particles have average lengths Lb and Lz along the block- and thickness directions, where Lb/Lz is in a range of about 100 to about 500, or about 150 to about 450, or about 200 to about 400, for example. Lb/Lz can be in any range described elsewhere herein. Lb′ increasing to Lb and Lz′ decreasing to Lz upon stretching are schematically illustrated in FIG. 11.

In some embodiments, the first temperature T1 is greater than melt temperatures of the minor and major phase materials 310 and 320. In some embodiments, the first temperature T1 is greater than about 200 degrees centigrade, or greater than about 220 degrees centigrade, or greater than about 240 degrees centigrade, or greater than about 260 degrees centigrade, or greater than about 270 degrees centigrade, for example. In some embodiments, the first temperature is less than about 400 degrees centigrade, for example. In some embodiments, the second temperature is about 5 to about 50, or about 5 to about 40, or about 5 to about 30, or about 5 to about 20, or about 8 to about 30 degrees centigrade greater the glass transition temperatures of the minor and major phase materials. In some such embodiments, or in other embodiments, prior to the stretching of the extruded mixture 264 along the block-direction at the second temperature T2, a temperature of the extruded mixture 264 is reduced to a third temperature T3 less than the second temperature T2. For example, the extruded mixture can be cast against a casting wheel (sometimes referred to in the art as a chill roll or a casting drum) to rapidly cool the mixture resulting in a cast film. In some embodiments, the third temperature T3 is about a room temperature (e.g., a temperature in a range of about 18 to about 30 degrees centigrade).

In some embodiments, the discrete domains 10′ in the extruded mixture at least mostly comprise the minor phase material. For example, the minor phase material can make up at least about 80 percent, or at least about 90 percent, or at least about 95 percent by weight of the domains. In some embodiments, the discrete domains in the extruded mixture are dispersed in a material at least mostly comprises the major phase material. For example, the major phase material can make up at least about 70 percent, or at least about 80 percent, or at least about 90 percent, or at least about 95 percent by weight of the material in which the domains are dispersed.

### EXAMPLES

TABLE 1
Materials Used in the Examples

| Name | Description | Source |
|---|---|---|
| PET Clear 62 | Polyethylene terephthalate (PET) | Made as the reaction |
| | with 0.62 intrinsic viscosity (IV) | product of terephthalic |
| | | acid and ethylene glycol |
| | | polymerized to a target |
| | | 0.62 IV (as measured in an |
| | | o-chlorobenzene/phenol |
| | | 60/40 solvent blend). |
| PET 9921 | Polyethylene terephthalate (PET) | Eastman Chemicals, |
| | with 0.80 intrinsic viscosity | Knoxville, TN |
| ZYLAR 960 | Impact modified styrene acrylic | Ineos Americas (League |
| | copolymer | City, TX) |
| STYROLUX | Styrene butadiene copolymer | Ineos Americas (League |
| 3G55 | | City, TX) |
| NAS 90 | Styrene methyl methacrylate | Ineos Americas (League |
| | | City, TX) |
| PETg | Glycol-modified PET copolyester | Eastman Chemicals |
| | available under the tradename GN071 | (Knoxville, TN) |
| PETg-i5 | Polyester-based ionomer | Made as described in U.S. |
| | | Pat. Appl. Pub. No. |
| | | 2007/0298271 (Liu et al.) |
| | | for “Polyester O”. |

Optically diffusive films of Comparative Examples C1-C5 and Example 1 were made via coextrusion and batch orienting using materials shown in Table 2. The temperature of the extruder was about 277 degrees Celsius.

TABLE 2

| | Material | % wt/pph | Material | % wt/pph | Material | % wt/pph | Thickness |
|---|---|---|---|---|---|---|---|
| Ex. | #1 | Mat. #1 | #2 | Mat. #2 | #3 | Mat. #3 | (μm) |
| C1 | PET Clear | 50%/5 | ZYLAR 960 | 30%/3 | PETg | 20%/2 | 88 |
| | 62 | | | | | | |
| C2 | PET Clear | 75%/7.5 | STYROLUX | 20%/2 | PETg-i5 | 5%/0.5 | 90 |
| | 62 | | 3G55 | | | | |
| C3 | PET Clear | 60%/9 | STYROLUX | 40%/6 | | | 125 |
| | 62 | | 3G55 | | | | |
| C4 | PET 9921 | 70%/7 | NAS 90 | 30%/3 | | | 88 |
| C5 | PET Clear | 70%/21 | STYROLUX | 30%/9 | | | 118 |
| | 62 | | 3G55 | | | | |
| 1 | PET 9921 | 70%/7 | NAS 90 | 30%/3 | | | 112 |

Material #1 and material #3 (when included) were the polyester phase materials and Materials #2 was the co-polystyrene phase material. The weight percent and the pounds per hour (pph) of these materials in the extruder input are indicated in Table 2. The polyester phase and the co-polystyrene phase were immiscible and exhibited two distinct phases after extrusion and after stretching.

After extrusion and before stretching, the extruded mixtures were cooled by casting the extruded mixtures against a casting wheel. For Example 1 and Comparative Examples C1 to C4, a two layer co-extrusion was performed where the layer already described (the blend layer) was on the air-side during the casting process and the wheel-side layer was composed of the same composition as the polyester phase in the blend layer and was fed at the same rate as the total blend layer. For Comparative Example C5, a 3 layer coextrusion was utilized where the center layer was the blend layer and the other two layers had the same composition as the polyester phase of the blend layer and each of the two streams was fed at a rate of half of the total blend layer rate. An 8″ extrusion die was used for all examples. The die gap was 60 mils for Example 1 and Comparative Examples C1-C4 and 100 mils for Comparative Example C5.

The stretching process for all these films was performed on a batch orienter (Karo IV from Brueckner Group, Portsmouth, NH). A pre-heat and stretch temperature of 95° C. was utilized. For Comparative Examples C1-C5, the stretching was a constrained stretch with a draw ratio of about 6:1 in the transverse direction (TD) orthogonal to the machine direction (MD). For Example 1, the stretching was a constrained stretch with a draw ratio of about 6:1 in the machine direction. PET stretched at these conditions has refractive indices of about 1.66 in the stretch direction (TD), 1.56 in the in-plane direction perpendicular to the stretch direction (the MD direction), and 1.53 in the thickness direction measured at 631 nm with a refractometer (Metricon Corporation, Pennington, NJ). The thicknesses of the films after stretching are given in Table 2.

The tendency of the films to scatter polarized light was characterized using a Haze Gard (BYK Corporation, Wesel, Germany). The haze of light polarized in the block direction (TD) was determined by positioning a high contrast ratio absorbing polarizer (with its pass-state transmission axis aligned with the stretch direction of the example film) on the incoming light side of the example film with transparent tape (3M 375 from 3M, Saint Paul, MN) applied to the air-side of the film to reduce scattering from the surface roughness of the example films. The samples were oriented so that the wheel-side of the film was toward the incoming light. For the pass-state haze the absorbing polarizer is aligned with the non-stretch direction (MD) of the example film. Results from the polarized haze measurements are provided in Table 3.

The angular distribution of the scattered light was measured with a Conoscope (ELDIM Corporation, Hérouville-Saint-Clair, France) with a cone angle of 80 degrees. A collimated white (LED) light source was utilized with an absorbing polarizer placed between the light source and the example film. Measurements were taken with the transmission axis of the polarized in the block direction and the Full Width Half Max (FWHM) of the scattering patterns along the MD and TD directions were determined and are reported in Table 3.

TABLE 3

| | | | FWHM | FWHM |
|---|---|---|---|---|
| | | | (degrees) | (degrees) |
| | | | Block State | Block State |
| | | | measured in | measured in |
| | | | scattering | scattering |
| | Haze (%) | | plane parallel | plane parallel |
| | Block | Haze (%) | to the MD | to the TD |
| Ex. | State | Pass State | direction | direction |
| C1 | 61.2 | 16.2 | 5 | 2 |
| C2 | 21 | 1.41 | 4 | 2 |
| C3 | 80.8 | 11.1 | 17 | 5 |
| C4 | 97.5 | 33.6 | 3 | 3 |
| C5 | 54.3 | 14.7 | 20 | 5 |
| 1 | 83.3 | 43.9 | 2 | 3.3 |

The reflective characteristics of the example films were determined by measuring the films reflectivity in an integrating sphere. The total reflectance, which is also referred to as the Reflectance with the Specular Included (RSIN), was measured by collecting all light reflecting from the example films impinging from all angles while the diffuse reflectance, which is also known as the Reflectance with the Specular Excluded (RSEX), was measured by allowing light to escape the integrating sphere that would produce a specular reflection. A LAMBDA 1050 spectrophotometer (PerkinElmer, Inc., Waltham, MA) was used in the measurements. The resulting reflectances averaged over a wavelength range of 450 nm to 650 nm are shown in Table 4.

TABLE 4

| | Diffuse | Total | Diffuse | Total |
|---|---|---|---|---|
| | Reflectance | Reflectance | Reflectance | Reflectance |
| | Block State | Block State | Pass State | Pass State |
| Ex. | (%) | (%) | (%) | (%) |
| C1 | 5.89 | 12.31 | 2.50 | 7.18 |
| C2 | 1.97 | 7.83 | 0.96 | 5.61 |
| C3 | 9.68 | 16.98 | 4.30 | 9.92 |
| C4 | 3.44 | 10.30 | 0.85 | 5.57 |
| C5 | 1.75 | 7.98 | 0.77 | 5.56 |
| 1 | 15.5 | 21.8 | 4.0 | 8.6 |

Average aspect ratios of the particles before stretching the cast films were determined using an optical microscope to examine cross-sections in the bz-plane and the pz-plane. The ratios Lp/Lz and Lb/Lz were determined for particles in the cross-section and an average of the ratios were determined. Results are provided in Table 5.

TABLE 5

| Ex. | Lp/Lz | Lb/Lz |
|---|---|---|
| C1 | 2.16 | 1.51 |
| C2 | 2.42 | 1.33 |
| C3 | 3.61 | 1.50 |
| C4 | 15.50 | 1.54 |
| C5 | 1.27 | 1.30 |
| 1 | 1.13 | 7.72 |

The corresponding aspect ratios for the stretched films were calculated assuming that the draw ratio of about 6 resulted in stretching by a factor of 6 in the stretch direction and thinning by a factor of 6 in the thickness direction, as would be expected for a constrained stretch as used in the Examples and Comparative Examples. Results are provided in Table 6.

TABLE 6

| Ex. | Lp/Lz | Lb/Lz |
|---|---|---|
| C1 | 12.94 | 54.51 |
| C2 | 14.51 | 47.98 |
| C3 | 21.63 | 54.00 |
| C4 | 93.01 | 55.40 |
| C5 | 7.62 | 46.97 |
| 1 | 6.77 | 278 |

Further results for Example 1 and Comparative Example C5 are shown in FIGS. 4-9.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optically diffusive film comprising a plurality of particles dispersed in a binder and elongated along an in-plane block-direction orthogonal to an in-plane pass direction and a thickness-direction of the optically diffusive film, the particles having average lengths Lb and Lz along the respective pass- and thickness-directions, Lb/Lz greater than about 100, for at least a first wavelength in a visible wavelength range extending from about 420 nm to about 680 nm, a magnitude of a difference between indices of refraction of the particles and the binder along the block-direction being at least about 0.04, a magnitude of a difference between indices of refraction of the particles and the binder along the pass-direction being less than about 0.05,
wherein, for a substantially collimated substantially normally incident light polarized along the block-direction and for the first wavelength, an optical transmittance of the optically diffusive film as a function of transmission angle comprises a substantially linear segment extending at least from about 10 degrees to about 60 degrees, the substantially linear segment having a best linear fit with an r-squared value greater than about 0.8.

17. The optically diffusive film of claim 16, wherein for a substantially collimated substantially normally incident light, for the visible wavelength range, and a polarization state along the pass-direction, the optically diffusive film has a total optical transmittance TT(P) and a diffuse optical transmittance TD(P), TD(P)/TT(P)≥0.15.

18. The optically diffusive film of claim 16, wherein, for a substantially collimated substantially normally incident light, for the visible wavelength range, and polarization states along the block- and the pass-directions, the optically diffusive film has respective total optical transmittances TT(B) and TT(P) and respective diffuse optical transmittances TD(B) and TD(P), TD(B)/TT(B)≥0.7, TD(P)/TT(P)≥0.15.

19. The optically diffusive film of claim 18, wherein TD(B)/TT(B) is greater than TD(P)/TT(P) by at least 0.1.

20. The optically diffusive film of claim 16, wherein for a substantially collimated substantially normally incident light, for an infrared wavelength range extending from about 700 nm to about 1000 nm, and polarization states along the block- and the pass-directions, the optically diffusive film has respective total optical transmittances TT′(B) and TT′(P) and respective diffuse optical transmittances TD′(B) and TD′(P), wherein TD′(B)/TT′(B) is greater than TD′(P)/TT′(P) by at least 0.4.

21. The optically diffusive film of claim 16, wherein for a substantially collimated substantially normally incident light polarized along the block-direction and for the first wavelength, the optically diffusive film diffusely transmits the incident light as a cone of transmitted light having respective full width at 30% maximums A(p) and A(b) along the respective pass- and block-directions, A(p)/A(b)≥2.

22. The optically diffusive film of claim 16, wherein Lb/Lz is in a range of about 150 to about 450.

23. The optically diffusive film of claim 16, wherein the r-squared value is greater than about 0.9.

24. The optically diffusive film of claim 16, wherein the magnitude of the difference between indices of refraction of the particles and the binder along the block-direction is greater than about 0.055, and the magnitude of the difference between indices of refraction of the particles and the binder along the pass-direction is less than about 0.04.

25. The optically diffusive film of claim 16, wherein the binder comprises a first thermoplastic polymer and the particles comprise a different second thermoplastic polymer.

26. The optically diffusive film of claim 16, wherein the binder comprises one or more of polyethylene terephthalate, glycol-modified polyethylene terephthalate, polyethylene naphthalate, and glycol-modified polyethylene naphthalate.

27. The optically diffusive film of claim 16, wherein the particles comprise a styrene-based polymer or copolymer.

28. An optical system comprising:
a display configured to emit an image for viewing by a viewer; and
the optically diffusive film of claim 16 disposed between the display and the viewer for diffusely transmitting the emitted image primarily along a viewing direction substantially parallel to the display so that the transmitted image has full viewing angles A(p) and A(b) along the respective viewing direction and a non-viewing direction orthogonal to the viewing direction and substantially parallel to the display, A(p)/A(b)≥2, the viewing and non-viewing directions substantially parallel to the respective pass- and block-directions.

29. The optical system of claim 28, wherein, for a substantially collimated substantially normally incident light and for the visible wavelength range:
the optically diffusive film has total optical transmittances TT(B) greater than about 40% and TT(P) greater than about 60% for the incident light polarized along the respective non-viewing and viewing directions; and
for the incident light polarized along the non-viewing direction and for the first wavelength in the visible wavelength range, the optically diffusive film has an average normalized optical transmittance of greater than about 0.2 over transmission angles of between about 5 degrees and about 20 degrees.

30. The optical system of claim 29, wherein for the incident light polarized along the non-viewing direction and for the first wavelength, the optically diffusive film has an average normalized optical transmission of greater than about 0.1 over transmission angles of between about 20 degrees and about 50 degrees.
